(19) United States
(12) Patent Application Publication
(10) Pub. No.: US 2019/0094057 A1
(43) Pub. Date: Mar. 28, 2019

(54) FLOW RATE SENSOR

(71) Applicant: DENSO CORPORATION, Kariya-city (JP)

(72) Inventor: Tomohide ARIKI, Kariya-city (JP)

(21) Appl. No.: 16/200,724

(22) Filed: Nov. 27, 2018

Related U.S. Application Data
(63) Continuation of application No. PCT/JP2017/017513, filed on May 9, 2017.

(30) Foreign Application Priority Data
Jun. 20, 2016 (JP) 2016-121567

(51) Int. Cl. G01F 15/14; G01F 1/58

(52) U.S. Cl. CPC G01F 15/14; G01F 1/582

(57) ABSTRACT

A flow rate sensor includes a sensing portion and a resin seal. The sensing portion includes a thin portion and an exposed portion. The thin portion has a smaller thickness as compared to other portions of the sensing portion. The exposed portion is exposed on the resin seal when the resin seal seals the sensing portion and includes a specified area corresponding to the thin portion and a peripheral area corresponding to an outer periphery of the thin portion. The sensing portion includes a recessed portion in a portion corresponding to the peripheral area. The recessed portion surrounds the thin portion and is recessed from the peripheral area toward the second surface. The sensing portion detects a flow rate of a fluid flowing along the thin portion.

### CROSS REFERENCE TO RELATED APPLICATIONS

The present application is a continuation application of International Patent Application No. PCT/JP2017/017513 filed on May 9, 2017, which designated the U.S. and claims the benefit of priority from Japanese Patent Application No. 2016-121567 filed on Jun. 20, 2016. The entire disclosures of all of the above applications are incorporated herein by reference.

### TECHNICAL FIELD

The present disclosure relates to a flow rate sensor configured to detect a flow rate of a fluid.

### BACKGROUND

Flow rate sensors may include a sensing portion and may be sealed by a resin seal. The resin seal may be formed by molding using a molding resin.

### SUMMARY

In one aspect of the present disclosure, a flow rate sensor includes a sensing portion and a resin seal. The sensing portion is in a plate form with a first surface and a second surface facing each other in a thickness direction of the sensing portion. The sensing portion includes a thin portion that is formed by a portion of the second surface recessed toward the first surface and that has a smaller thickness as compared to other portions of the sensing portion. The sensing portion is configured to detect a flow rate of a fluid flowing along a specified area of the first surface corresponding to the thin portion. The resin seal seals the sensing portion. The resin seal allows an exposed portion to be exposed on the resin seal. The exposed portion is a part of the first surface and includes a specified area corresponding to the thin portion and a peripheral area corresponding to an outer periphery of the thin portion.

The sensing portion includes a recessed portion within the peripheral area. A part of the first surface in the peripheral area is recessed toward the second surface to form the recessed portion. The recessed portion surrounds the thin portion.

### BRIEF DESCRIPTION OF DRAWINGS

The above and other objects, features and advantages of the present disclosure will become more apparent from the following detailed description referring to the drawings described herein.

FIG. 1 is a plan view of a flow rate sensor in a first embodiment of the present disclosure.

FIG. 2 is a cross-sectional view taken along line II-II in FIG. 1.

FIG. 3 is a plan view of a flow rate sensor in a second embodiment.

FIG. 4 is a cross-sectional view taken along line IV-IV in FIG. 1.

FIG. 5 is a cross-sectional view of a flow rate sensor in a third embodiment.

FIG. 6 is a cross-sectional view of a flow rate sensor in a fourth embodiment.

FIG. 7 is a cross-sectional view of a flow rate sensor in a fifth embodiment.

FIG. 8 is a cross-sectional view of a flow rate sensor in a sixth embodiment.

FIG. 9 is a cross-sectional view of a flow rate sensor in a seventh embodiment.

FIG. 10 is a cross-sectional view of a flow rate sensor in an eighth embodiment.

FIG. 11 is a cross-sectional view of a flow rate sensor in a ninth embodiment.

### DETAILED DESCRIPTION

As an example, a flow rate sensor may include a substrate and an organic protective film. The substrate includes a thin portion that is formed in a surface layer of the substrate and that has a smaller thickness along a thickness direction of the substrate as compared to other portions of the substrate. The substrate is in a plate form with a first surface and a second surface facing each other in the thickness direction. The organic protective film is attached to the first surface to surround the thin portion.

The organic protective film includes a central portion covering the thin portion and a peripheral portion surrounding the central portion on an outer side of the central portion. The central portion of the organic protective film prevents foreign materials from attaching to the thin portion. The flow rate sensor further includes a resin seal sealing the substrate. The resin seal covers an outer periphery of the peripheral portion and does not cover the central portion. As such, the thin portion is exposed on the resin seal. The flow rate sensor detects a flow rate of a fluid flowing along the thin portion exposed on the resin seal.

The resin seal may be molded in the following manner. A first mold for exposing the thin portion is pressed against an inner periphery of the peripheral portion. The first mold with the substrate is placed inside a second mold. A clearance is formed between the first mold and the second mold at this stage. Subsequently, the clearance is filled with a molding resin. By removing the first and second molds, the resin seal is provided with the substrate including the thin portion exposed on the resin seal.

However, when the peripheral portion of the organic protective film has a rough surface, a clearance may be formed between the peripheral portion of the organic protective surface and the first mold, and the molding resin would leak through the clearance. The molding resin leaking through the clearance would affect the thin portion.

The occurrence of the clearance may be suppressed when the first mold is pressed against the peripheral portion strongly. However, organic protective films may have nano-order thicknesses. The thickness may be about 10 μm at the largest. As such, the peripheral portion of the organic protective film would not be able to reduce/disperse stress applied to the peripheral portion from the first mold when the first mold is pressed against the peripheral portion strongly. In other words, the organic protective film may not be able to bear the stress applied to the peripheral portion. Therefore, the first mold is hardly pressed against the peripheral portion strongly to seal the clearance formed between the first mold and the peripheral portion of the organic protective film.

In addition, the central portion of the organic protective film functions to prevent the foreign materials from attaching to the thin portion. As such, the central portion may hardly block a flow of the molding resin flowing through the clearance.

The present disclosure is directed to a flow rate sensor that can block a flow of the molding resin before the molding resin reaches the thin portion.

Hereinafter, embodiments for implementing the present disclosure will be described referring to drawings. In each embodiment, portions corresponding to the elements described in the preceding embodiments are denoted by the same reference numerals, and redundant explanation may be omitted. In each of the embodiments, when only a part of the configuration is described, the other parts of the configuration can be applied to the other embodiments described above. The present disclosure is not limited to combinations of embodiments which combine parts that are explicitly described as being combinable. As long as no harm is present, the various embodiments may be partially combined with each other even if not explicitly described.

### First Embodiment

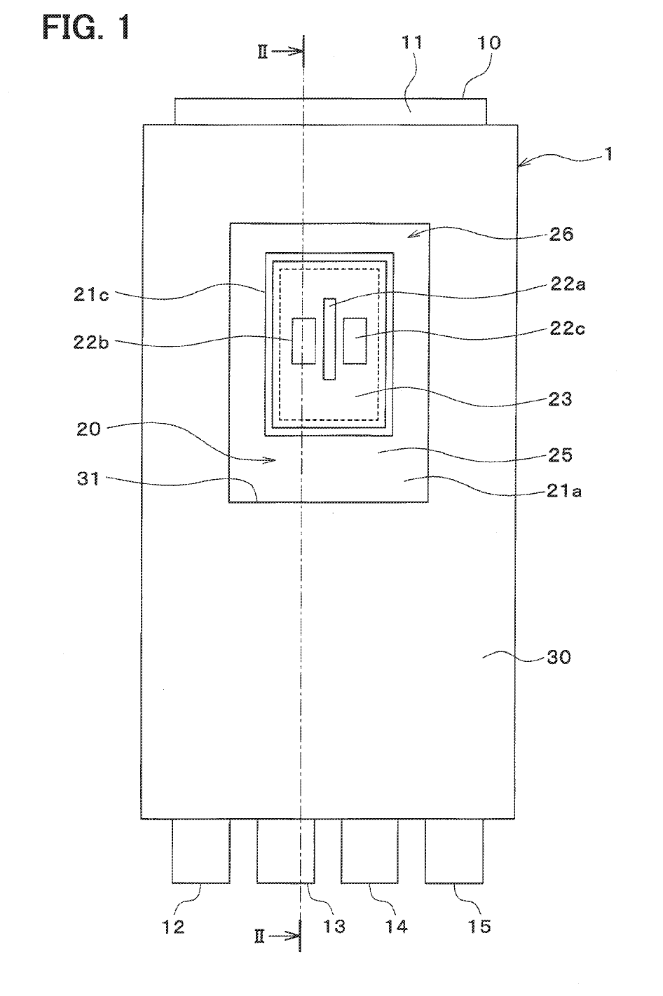

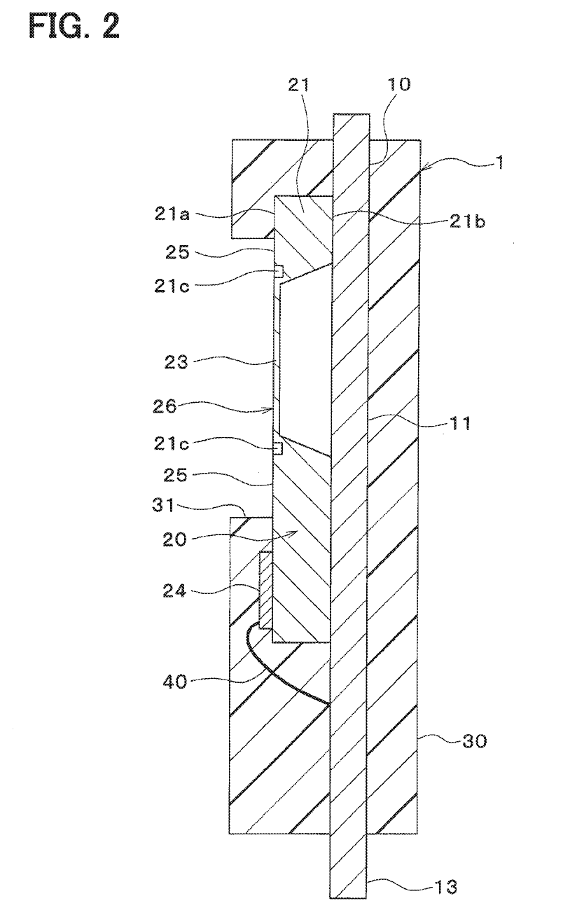

A first embodiment will be described with reference to the drawings. As shown in FIG. 1 and FIG. 2, a flow rate sensor 1 includes a lead frame 10, a sensing portion 20, and a resin seal 30.

The lead frame 10 is formed by a single metal plate by a method such as punching to have a specified shape. The metal plate is made of metal such as copper. The lead frame 10 includes an island 11 and a plurality of leads 12, 13, 14, 15.

The island 11 mounts a semiconductor substrate 21. The leads 12, 13, 14, 15 serve as wirings. As an example, the lead 12 serves as a wiring connected to a power source, the lead 13 serves as a ground, and the leads 14, 15 serve as wirings transmitting signals. The lead 13 is connected to the island 11.

The sensing portion 20 detects a flow rate of a fluid such as gas. In the present embodiment, the fluid is air. The sensing portion 20 includes the semiconductor substrate 21, a heating resistor 22a, an upstream thermometric resistor 22b, and a downstream thermometric resistor 22c. In FIG. 2, illustrations of the heating resistor 22a, the upstream thermometric resistor 22b, and the downstream thermometric resistor 22c are omitted.

The semiconductor substrate 21 is in a plate form with a top surface 21a and a back surface 21b facing each other in a thick direction of the semiconductor substrate 21. The top surface 21a and the back surface 21b of the semiconductor substrate 21 will be referred to as a first surface and a second surface respectively. As an example, the semiconductor substrate 21 may be a silicon substrate.

The semiconductor substrate 21 includes a thin portion 23. The thin portion 23 has a smaller thickness in the thickness direction as compared to other portions of the semiconductor substrate 21. Specifically, the semiconductor substrate 21 includes a portion that is recessed from the back surface 21b toward the top surface 21a along the thickness direction to form the thin portion 23. In other words, a part of the back surface 21b is recessed toward the top surface 21a along the thickness direction to form the thin portion 23. That is, the semiconductor substrate 21 defines a bottomed hole therein that is open in the back surface 21b and extends along the thickness direction. A bottom of the bottomed hole serves as the thin portion 23.

As shown in FIG. 1, the heating resistor 22a, the upstream thermometric resistor 22b, and the downstream thermometric resistor 22c are arranged in the thin portion 23 of the semiconductor substrate 21. Specifically, the heating resistor 22a is located between the upstream thermometric resistor 22b and the downstream thermometric resistor 22c along a flow direction of the air. The upstream thermometric resistor 22b is located upstream of the heating resistor 22a, and the downstream thermometric resistor 22c is located downstream of the heating resistor 22a.

As an example, each of the heating resistor 22a, the upstream thermometric resistor 22b and the downstream thermometric resistor 22c may include a silicon layer including impurities diffused in the silicon layer by a method such as thermal diffusion. The heating resistor 22a, the upstream thermometric resistor 22b, and the downstream thermometric resistor 22c are insulated from the semiconductor substrate 21 by an insulator made of a material such as SiO₂.

A plurality of aluminum wirings (Al wirings) 24 are arranged on the top surface 21a of the semiconductor substrate 21. The Al wirings 24 connect the heating resistor 22a, the upstream thermometric resistor 22b and the downstream thermometric resistor 22c to the leads 12, 13, 14, 15 electrically. Specifically, the Al wirings 24 are electrically connected with the leads 12, 13, 14, 15 via bonding wires 40 respectively.

The resin seal 30 seals a part of the lead frame 10 and a part of the sensing portion 20. Specifically, the resin seal 30 seals the lead frame 10 so that an end of the island 11 away from the leads 12, 13, 14, 15 and ends of the leads 12, 13, 14, 15 are exposed on the resin seal 30. The end of the island 11 away from the leads 12, 13, 14, 15 is located outside the resin seal 30 on one side of the resin seal 30 along a longitudinal direction of the flow rate sensor 1 perpendicular to the flow direction of the air. The ends of the leads 12, 13, 14, 15 are located outside the resin seal 30 on the other side of the resin seal 30 facing the one side of the resin seal 30 along the longitudinal direction.

The top surface 21a of the semiconductor substrate 21 includes an exposed portion 26 exposed on the resin seal 30. The exposed portion 26 includes a specified area corresponding to the thin portion 23 and a peripheral area 25 corresponding to an outer periphery of the thin portion 23.

The top surface 21a further includes a recessed portion located between the thin portion 23 and a rim of the top surface 21a. In other words, the recessed portion is located outside the thin portion 23 in the top surface 21a and extends along the thin portion 23 annularly. That is, the recessed portion is formed into a groove. As such, the recessed portion will be referred to as a groove 21c hereafter. More specifically, the groove 21c is formed within the peripheral area 25 of the exposed portion 26. The groove 21c is recessed from the top surface 21a toward the back surface 21b and extends continuously, e.g., annularly, to surround the thin portion 23 seamlessly.

The resin seal 30 seals the sensing portion 20 so that the exposed portion 26 is exposed on the resin seal 30. More specifically, the resin seal 30 includes an opening 31 through which the exposed portion 26 is exposed on the resin seal 30.

As an example, the groove 21c in the present embodiment is formed into a square frame as shown in FIG. 1. A depth of the groove 21c may be within a range between tens of micrometers (μm) and hundreds of micrometers (μm). More specifically, the groove 21c has a square shape in a cross section parallel to the thickness direction of the semiconductor substrate 21 as shown in FIG. 2. However, the groove 21c may have any shapes in the cross section parallel to the thickness direction. As an example, the groove 21c may have a semicircular shape in the cross section.

The flow rate sensor 1 having the above-described configuration is housed in a housing. The housing includes a circuit chip and a connecting terminal. The circuit chip controls currents applied to the heating resistor 22a, the upstream thermometric resistor 22b, and the downstream thermometric resistor 22c. The connecting terminal connects the flow rate sensor 1 to other devices electrically. The housing defines a passage therein through which air flows. The flow rate sensor 1 detects a flow rate of the air. As such, the air is a measuring object.

The flow rate of the air is measured in the following manner. The circuit chip controls, by a feedback control, a temperature of the heating resistor 22a such that the temperature of the heating resistor 22a becomes higher than a temperature of the air. The upstream thermometric resistor 22b detects a temperature of the air on an upstream side of the heating resistor 22a in the flow direction of the air. The downstream thermometric resistor 22c detects a temperature of the air on a downstream side of the heating resistor 22a in the flow direction of the air. The circuit chip calculates the flow rate based on a temperature difference between the temperature detected by the upstream thermometric resistor 22b and the temperature detected by the downstream thermometric resistor 22c. Thus, the flow rate sensor 1 detects the flow rate of the air flowing along the specified area of the top surface 21a of the semiconductor substrate 21 corresponding to the thin portion 23. In other words, the sensing portion 20 detects the flow rate of the air flowing along the thin portion 23.

A manufacturing method for manufacturing the flow rate sensor 1 will be described hereafter. The lead frame 10 and the sensing portion 20 are provided separately from each other. The lead frame 10 is made of a metal plate by a method such as punching as described above.

The sensing portion 20 is provided in the following manner. A masking material is applied to the back surface 21b of the semiconductor substrate 21. A portion of the masking material is removed so that a portion of the back surface 21b corresponding to the thin portion 23 is exposed on the masking material. The portion of the back surface 21b exposed on the masking material is etched. Thus, the thin portion 23 is formed in the semiconductor substrate 21 on a side adjacent to the top surface 21a. Subsequently, the masking material is removed.

The heating resistor 22a, the upstream thermometric resistor 22b, the downstream thermometric resistor 22c and the Al wirings 24 are arranged on the top surface 21a of the semiconductor substrate 21. At the same time, the groove 21c is formed in the top surface 21a of the semiconductor substrate 21. Alternatively, the groove 21c may be formed before arranging the heating resistor 22a, the upstream thermometric resistor 22b and the downstream thermometric resistor 22c on the top surface 21a.

The groove 21c may be formed directly in the semiconductor substrate 21 by a method such as patterning or etching.

When forming the groove 21c by patterning, a masking material is applied to the top surface 21a of the semiconductor substrate 21 into the square shape correspondingly to the groove 21c. A material forming the semiconductor substrate 21 is accumulated on the rest portion of the top surface 21a of the semiconductor substrate 21 not covered by the masking material. By removing the masking material, the groove 21c is formed on the portion of the top surface 21a which has been covered by the masking material.

When forming the groove 21c by etching, a masking material is applied to the top surface 21a of the semiconductor substrate 21, and a portion of the masking material is removed into the square shape correspondingly to the groove 21c. As such, a portion of the top surface 21a is exposed on the masking material into the square shape correspondingly to the groove 21c. The exposed portion of the top surface 21a exposed on the masking material is etched. By removing the masking material, the groove 21c is formed in the portion of the top surface 21a which has not been covered by the masking material.

The sensing portion 20 is mounted to the island 11 of the lead frame 10. The Al wirings 24 of the sensing portion 20 are connected to the leads 12, 13, 14, 15 by the bonding wires 40 respectively.

The resin seal 30 is molded in the following manner. The sensing portion 20 is mounted to the lead frame 10 to be one workpiece. The workpiece is placed in a mold. The mold includes a lower mold and an upper mold. The workpiece is place on the lower mold, and then the upper mold is coupled with the lower mold. When the upper mold and the lower mold are coupled, an inner space is defined between the upper mold and the lower mold.

The upper mold includes a protrusion. When the upper mold and the lower mold are coupled, the protrusion protrudes from an inner surface of the upper mold toward the lower mold. The protrusion is at a position corresponding to the exposed portion 26. The upper mold may be formed integrally with the protrusion or may be formed separately from the protrusion and coupled with the protrusion.

A protrusion end surface of the protrusion comes in contact with the exposed portion 26 of the top surface 21a when the upper mold and the lower mold are coupled. A protective film that protects the exposed portion 26 is attached to the protrusion end surface of the protrusion so that the protection film covers the exposed portion 26 when the resin seal 30 is formed. As an example, the protection film may be an organic film or an inorganic film.

The upper mold and the lower mold are coupled and fastened to each other with the workpiece placed therebetween. A molding resin is infused into the inner space of the mold from a gate portion while the workpiece is positioned inside the inner space with the protective film retained between the protrusion end surface of the protrusion and the exposed portion 26. The protrusion of the upper mold does not allow the molding resin to flow into the protrusion. As such, the protrusion provides the opening 31 of the resin seal 30. By curing the molding resin, the resin seal 30 is formed. The flow rate sensor 1 is provided by removing the mold from the resin seal 30.

In the molding, when a clearance is defined between the top surface 21a of the sensing portion 20 and the upper mold, a clearance would be defined between the protrusion end surface of the protrusion and the exposed portion 26. In this case, the molding resin would leak into the clearance defined between the protrusion end surface of the protrusion and the exposed portion 26 and would reach the thin portion 23 formed within the exposed portion 26. When the molding resin reaches the thin portion 23, the molding resin would harm the thin portion 23.

In the present embodiment, the sensing portion 20 includes the groove 21c surrounding the thin portion 23. As such, even if the molding resin leaks into the clearance defined between the protrusion of the upper mold and the exposed portion 26, the molding resin flows into the groove 21c. Therefore, the groove 21c prevents the molding resin from reaching the thin portion 23.

In addition, the protective film is attached only to the exposed portion 26 and is not attached to a whole of the top surface 21a of the semiconductor substrate 21 in the present embodiment. As such, a thermal capacity of the sensing portion 20 can be reduced. Reducing the thermal capacity of the sensing portion 20 results in reducing an excess heat transfer. Therefore, the heating resistor 22a, the upstream thermometric resistor 22b and the downstream thermometric resistor 22c can respond quickly.

Moreover, since the top surface 21a is not covered by the organic protective film or the inorganic protective film, a variation in the thermal capacity of the sensing portion 20 can be reduced. Reducing the variation in the thermal capacity of the sensing portion 20 results in stabilizing a heat generation of the heating resistor 22a, i.e., stabilizing a temperature of the heating resistor 22a. Therefore, the flow rate sensor 1 can detect the flow rate of the air with high accuracy.

### Second Embodiment

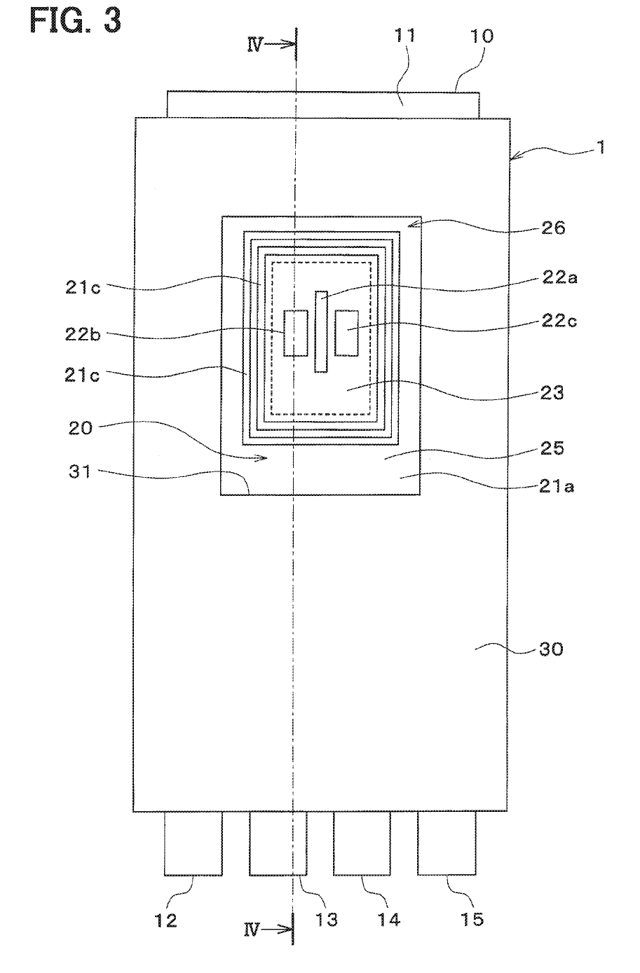

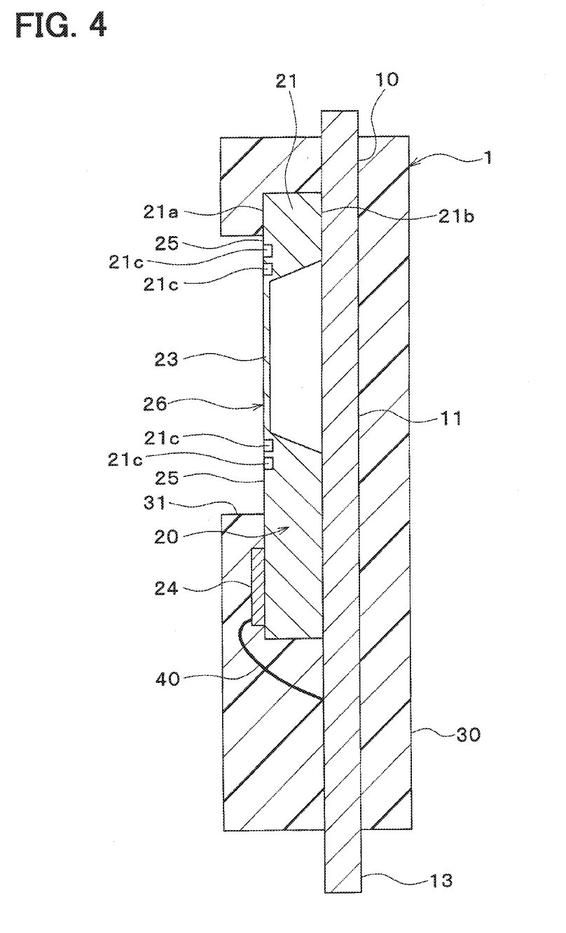

In the present embodiment, as shown in FIG. 3 and FIG. 4, the sensing portion 20 includes two grooves 21c. As such, the molding resin can be prevented from flowing to the thin portion 23 certainly.

A quantity of the grooves 21c may not be limited to two and may be three or more. By providing a plurality of grooves 21c, the grooves 21c certainly prevent the molding resin from reaching the thin portion 23.

### Third Embodiment

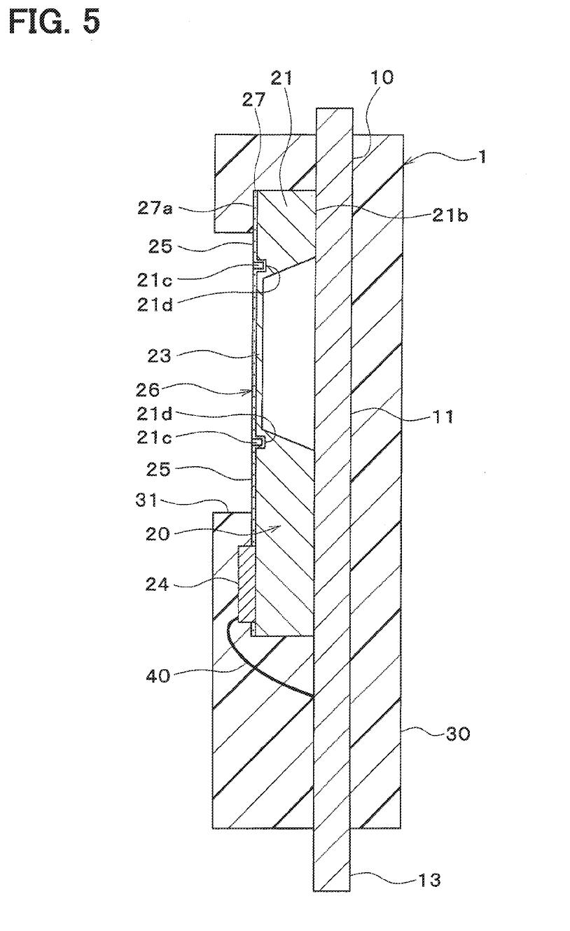

In the present embodiment, as shown in FIG. 5, the sensing portion 20 includes an inorganic protective film 27. The inorganic protective film 27 covers an inner surface 21d of the groove 21c and a whole of the top surface 21a of the semiconductor substrate 21 including the thin portion 23. As such, a whole of a surface 27a of the inorganic protective film 27 serves as a first surface of the sensing portion 20 in the present embodiment. As an example, the inorganic protective film 27 may be made of SiN.

The inorganic protective film 27 is attached along the inner surface 21d of the groove 21c. In other words, the inorganic protective film 27 does not fill the groove 21c. As such, the groove 21c still prevents the molding resin from flowing to the thin portion 23. The Al wirings 24 are arranged on the inorganic protective film 27.

The inorganic protective film 27 protects the thin portion 23, the Al wirings 24 and other wirings from heat, water, foreign materials or the like. Specifically, the wirings made of metal would be corroded easily. As such, providing the inorganic protective film 27 is beneficial to suppress occurrence of the damage of the wirings due to the corrosion.

### Fourth Embodiment

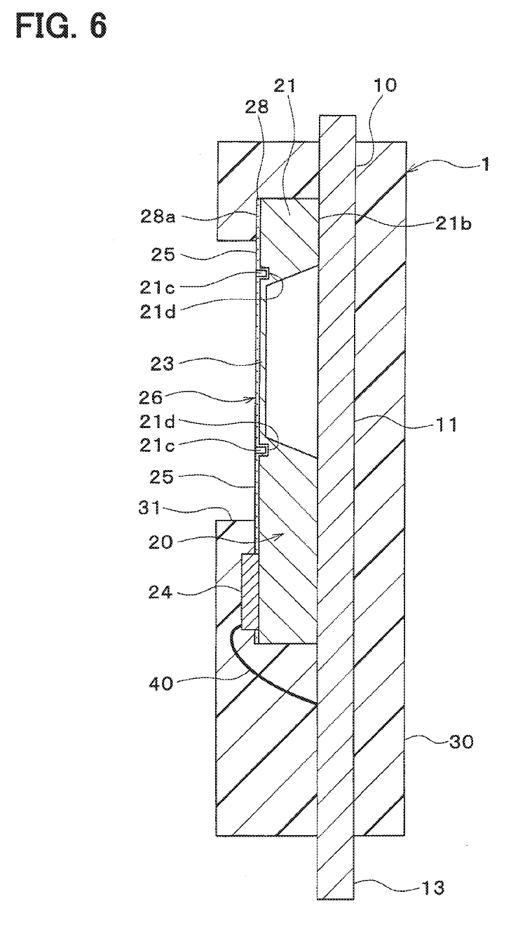

In the present embodiment, as shown in FIG. 6, the sensing portion 20 includes an oil soluble film 28 instead of the inorganic protective film 27 described in the third embodiment. The oil soluble film 28 is an inorganic film having water repellency. The oil soluble film 28 covers the inner surface 21d of the groove 21c and a whole of the top surface 21a. As such, a surface 28a of the oil soluble film 28 as a whole serves as the first surface of the sensing portion 20. The oil soluble film 28 is applied to the top surface 21a of the semiconductor substrate 21 and the inner surface 21d of the groove 21c by a method such as screen printing or ink-jet printing.

The oil soluble film 28 is applied along the inner surface 21d of the groove 21c and does not fill the groove 21c. As such, even if a clearance is formed between the surface 28a of the oil soluble film 28 and the upper mold in the molding and the molding resin leaks into the clearance, the groove 21c can prevent the molding resin from flowing to the thin portion 23. In addition, the oil soluble film 28 has water repellency. As such, the oil soluble film 28 also prevents the molding resin from reaching the thin portion 23.

### Fifth Embodiment

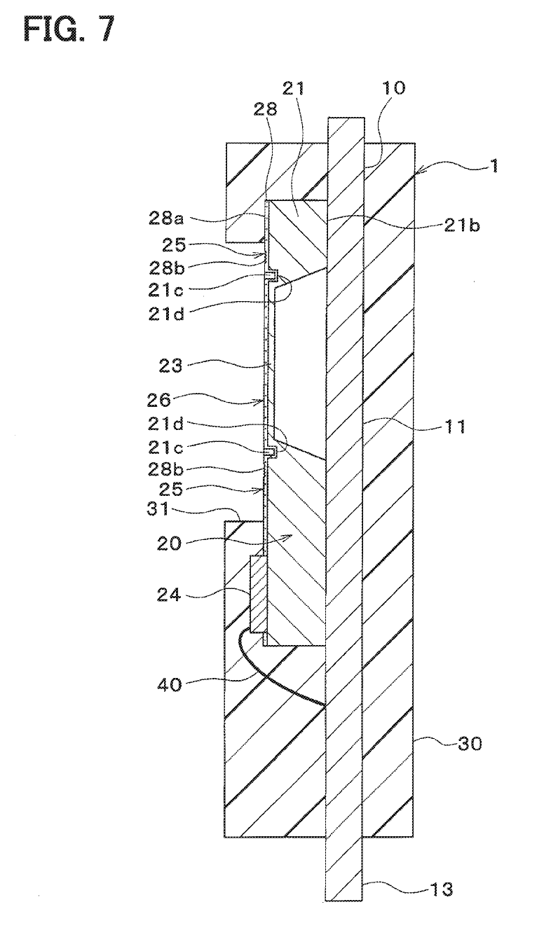

In the present embodiment, as shown in FIG. 7, the oil soluble film 28 is roughened partially to include a rough surface 28b. The rough surface 28b is formed in a portion of the surface 28a corresponding to the peripheral area 25. That is, the rough surface 28b serves as a part of the surface 28a of the oil soluble film 28.

As an example, the rough surface 28b may be formed by roughening the surface 28a of the oil soluble film 28 with laser. The rough surface 28b extends continuously to surround the groove 21c. Specifically, the rough surface 28b is formed on an outer side of the groove 21c within the peripheral area 25. Since the rough surface 28b is not a smooth surface, the molding resin hardly flows across the rough surface 28b due to friction against the rough surface 28b. As a result, the molding resin can be effectively prevented from flowing to the thin portion 23 by the combination of the groove 21c and the rough surface 28b.

The rough surface 28b is not limited to extend continuously and may be extend intermittently on the outer side of the groove 21c. Alternatively, the rough surface 28b may be formed partially on the outer side of the groove 21c. Alternatively, the rough surface 28b may be formed outside the peripheral area 25 in the surface 28a of the oil soluble film 28. As an example, the rough surface 28b may be formed in a portion of the surface 28a of the oil soluble film 28 corresponding to the thin portion 23.

### Sixth Embodiment

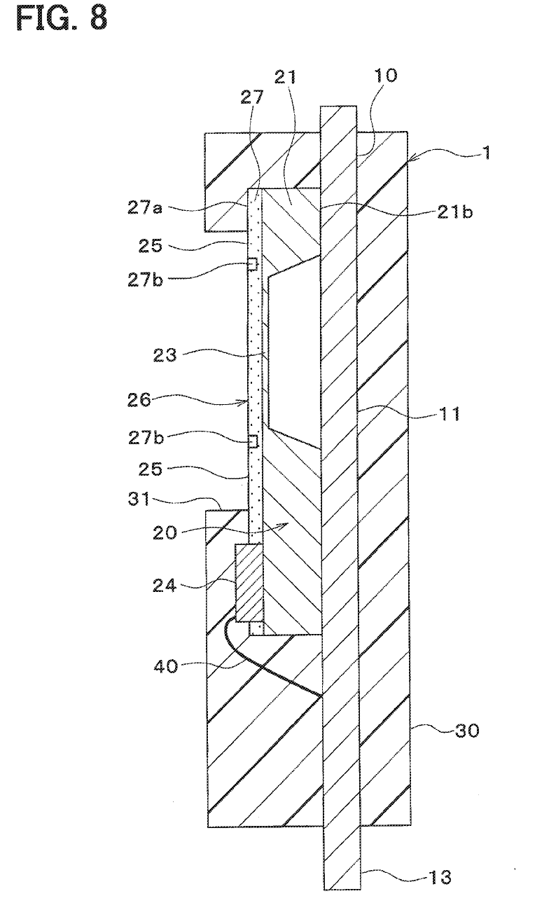

The present embodiment is different from the third embodiment in a structure of the inorganic protective film 27. As shown in FIG. 8, the sensing portion 20 includes the inorganic protective film 27 that covers a whole of the top surface 21a of the semiconductor substrate 21 including the thin portion 23. Therefore, a surface 27a of the inorganic protective film 27 serves as the first surface of the sensing portion 20 in the present embodiment. The surface 27a includes the exposed portion 26 including the specified area corresponding to the thin portion 23 and the peripheral area 25.

In the present embodiment, the recessed portion surrounding the thin portion 23 is provided within the peripheral area 25 of the inorganic protective film 27. The recessed portion in the present embodiment will be referred to as a groove 27b. The groove 27b is a part of the inorganic protective film 27 and is recessed toward the back surface 21b of the semiconductor substrate 21. The groove 27b is not formed in the semiconductor substrate 21. In other words, a bottom of the groove 27b is distanced from the top surface 21a of the semiconductor substrate 21.

A quantity of the groove 27b of the inorganic protective film 27 is not limited to be one and may be two or more similar to the second embodiment. According to the one or more groove 27b, the same effects as the first and third embodiments can be obtained.

### Seventh Embodiment

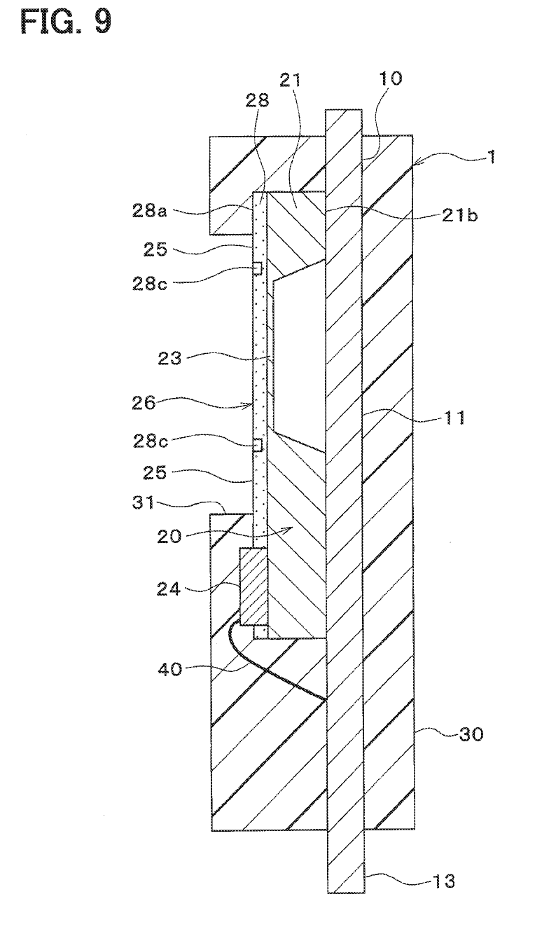

In the present embodiment, as shown in FIG. 9, the sensing portion 20 includes the oil soluble film 28 instead of the inorganic protective film 27 described in the sixth embodiment.

The oil soluble film 28 covers a whole of the top surface 21a of the semiconductor substrate 21. As such, the surface 28a of the oil soluble film 28 serves as the first surface of the sensing portion 20 in the present embodiment. The surface 28a includes the exposed portion 26 including the specified area corresponding to the thin portion 23 and the peripheral area 25.

In the present embodiment, the recessed portion surrounding the thin portion 23 is provided within the peripheral area 25 of the oil soluble film 28. The recessed portion in the present embodiment will be referred to as a groove 28c.

The groove 28c is a part of the oil soluble film 28 and is recessed toward the back surface 21b of the semiconductor substrate 21. The groove 28c is not formed in the semiconductor substrate 21. In other words, a bottom of the groove 28c is distanced from the top surface 21a of the semiconductor substrate 21.

In the present embodiment, the same effects as the first, fourth and sixth embodiments can be obtained.

### Eighth Embodiment

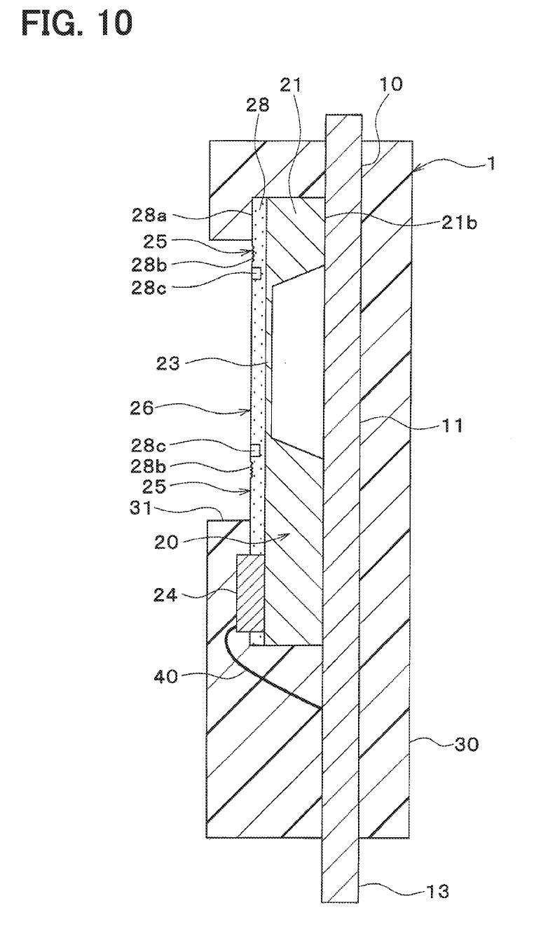

The present embodiment shown in FIG. 10 is different from the seventh embodiment in a structure of the oil soluble film 28. The oil soluble film 28 includes the rough surface 28b on the outer side of the groove 28c in the peripheral area 25. As such, the same effects as the fifth embodiment can be obtained in addition to the same effects as the seventh embodiment.

### Ninth Embodiment

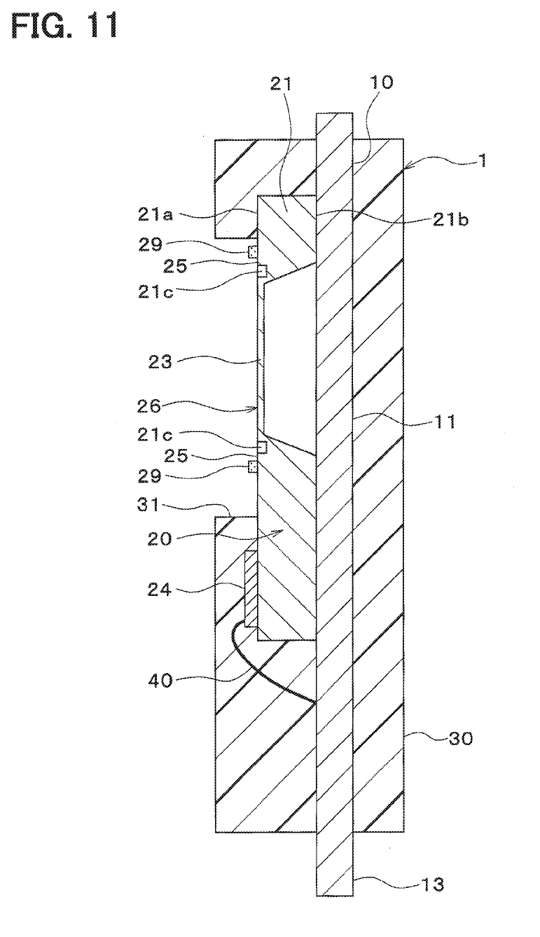

In the present embodiment, as shown in FIG. 11, the sensing portion 20 includes an organic protective film 29. The organic protective film 29 is formed on the outer side of the groove 21c within the peripheral area 25 of the semiconductor substrate 21. The organic protective film 29 extends continuously to surround the groove 21c. The organic protective film 29 may be formed into a frame shape.

The organic protective film 29 protrudes from the top surface 21a of the semiconductor substrate 21 on the outer side of the groove 21c. In addition, the organic protective film 29 is made of a soft material. As such, the organic protective film 29 can reduce/disperse stress applied to the thin portion 23 when arranging the heating resistor 22a, the upstream thermometric resistor 22b and the downstream thermometric resistor 22c. As a result, the organic protective film 29 can prevent the semiconductor substrate 21 from being damaged when arranging the heating resistor 22a, the upstream thermometric resistor 22b and the downstream thermometric resistor 22c. Furthermore, since the organic protective film 29 protrudes from the top surface 21a of the semiconductor substrate 21, the organic protective film 29 prevents foreign materials from attaching to the thin portion 23.

The organic protective film 29 may be formed not to extend continuously to surround the groove 21c, 27b or 28c. The organic protective film 29 may be formed either on the inner side or on the outer side of the rough surface 28b.

The present embodiment may be modified to further include the inorganic protective film 27 described in the third and sixth embodiments. In this case, the surface 27a of the inorganic protective film 27 serves as the first surface of the semiconductor substrate 21. As such, the organic protective film 29 may be formed within the exposed portion 26 of the surface 27a of the inorganic protective film 27.

Alternatively, the present embodiment may be modified to further include the oil soluble film 28 described in the fourth, fifth, seventh and eighth embodiments. In this case, the surface 28a of the oil soluble film 28 serves as the first surface of the semiconductor substrate 21. As such, the organic protective film 29 may be formed within the exposed portion 26 of the surface 28a of the oil soluble film 28.

### Other Embodiments

The present disclosure is not limited to the above embodiments but can be modified as appropriate within the scope described in the present disclosure. Individual elements or features of a particular embodiment are generally not limited to that particular embodiment, but, where applicable, are interchangeable and can be used in a selected embodiment, even if not specifically shown or described. Individual elements or features of a particular embodiment are not necessarily essential unless it is specifically stated that the elements or the features are essential in the foregoing description, or unless the elements or the features are obviously essential in principle.

A quantity, a value, an amount, a range, or the like, if specified in the above-described example embodiments, is not necessarily limited to the specific value, amount, range, or the like unless it is specifically stated that the value, amount, range, or the like is necessarily the specific value, amount, range, or the like, or unless the value, amount, range, or the like is obviously necessary to be the specific value, amount, range, or the like in principle. Furthermore, a material, a shape, a positional relationship, or the like, if specified in the above-described example embodiments, is not necessarily limited to the specific material, shape, positional relationship, or the like unless it is specifically stated that the material, shape, positional relationship, or the like is necessarily the specific material, shape, positional relationship, or the like, or unless the material, shape, positional relationship, or the like is obviously necessary to be the specific material, shape, positional relationship, or the like in principle.

In the above-described embodiments, the exposed portion 26 is formed into a square shape in a planer view as an example. The exposed portion 26 may have any shapes in the planer view.

What is claimed is:

1. A flow rate sensor comprising:
a sensing portion in a plate form, the sensing portion configured to detect a flow rate of a fluid; and
a resin seal sealing the sensing portion, wherein
the sensing portion includes
a semiconductor substrate including a thin portion, the thin portion having a smaller thickness in the thickness direction as compared to other portions of the semiconductor substrate, and
an inorganic protective film attached to the semiconductor substrate to cover the thin portion,
the semiconductor substrate includes
a first surface including an exposed portion that includes a specified area corresponding to the thin portion and a peripheral area corresponding to an outer periphery of the thin portion, and
a second surface facing the first surface in a thickness direction of the sensing portion, the second surface including a portion that is recessed toward the first surface along the thickness direction to form the thin portion,
the inorganic film includes a recessed portion within a portion corresponding to the peripheral area and between the thin portion and a rim of the first surface,
the recessed portion extends to surround the thin portion and is recessed toward the second surface, and
the sensing portion is configured to detect the flow rate of the fluid flowing along the thin portion.

2. A flow rate sensor comprising:
a sensing portion in a plate form, the sensing portion configured to detect a flow rate of a fluid; and
a resin seal sealing the sensing portion, wherein
the sensing portion includes
a semiconductor substrate including a thin portion, the thin portion having a smaller thickness in the thickness direction as compared to other portions of the semiconductor substrate, and
an oil soluble film attached to the semiconductor substrate to cover the thin portion and having water repellency,
the semiconductor substrate includes
a first surface including an exposed portion that includes a specified area corresponding to the thin portion and a peripheral area corresponding to an outer periphery of the thin portion, and
a second surface facing the first surface in a thickness direction of the sensing portion, the second surface including a portion that is recessed toward the first surface along the thickness direction to form the thin portion,
the oil soluble film includes a recessed portion within a portion corresponding to the peripheral area and between the thin portion and a rim of the first surface,
the recessed portion extends to surround the thin portion and is recessed toward the second surface, and
the sensing portion is configured to detect the flow rate of the fluid flowing along the thin portion.

3. The flow rate sensor according to claim 2, wherein
the oil soluble film includes a rough surface at least in the portion corresponding to the peripheral area.

4. A flow rate sensor comprising:
a sensing portion in a plate form, the sensing portion configured to detect a flow rate of a fluid; and
a resin seal sealing the sensing portion, wherein
the sensing portion includes
a semiconductor substrate including a thin portion, the thin portion having a smaller thickness in the thickness direction as compared to other portions of the semiconductor substrate, and
an oil soluble film having water repellency,
the semiconductor substrate includes
a first surface including an exposed portion that includes a specified area corresponding to the thin portion and a peripheral area corresponding to an outer periphery of the thin portion,
a second surface facing the first surface in a thickness direction of the sensing portion, the second surface including a portion that is recessed toward the first surface along the thickness direction to form the thin portion, and
a recessed portion formed within the peripheral area of the first surface and between the thin portion and a rim of the first surface,
the recessed portion extends to surround the thin portion and is recessed toward the second surface, and
the oil soluble film covers the first surface of the semiconductor substrate and an inner surface of the recessed portion and includes a rough surface at least in a portion corresponding to the peripheral area of the first surface, and
the sensing portion is configured to detect the flow rate of the fluid flowing along the thin portion.

5. The flow rate sensor according to claim 1, wherein
the recessed portion is one of a plurality of recessed portions formed in the sensing portion.

6. The flow rate sensor according to claim 1, wherein
the sensing portion includes an organic protective film that extends to surround the recessed portion on an outer side of the recessed portion in the peripheral area.
